(19) United States
(12) Patent Application Publication
(10) Pub. No.: US 2018/0302264 A1
(43) Pub. Date: Oct. 18, 2018

(54) HYBRID CLOCK DATA RECOVERY CIRCUITRY FOR PULSE AMPLITUDE MODULATION SCHEMES

(71) Applicant: Intel Corporation, Santa Clara, CA (US)

(72) Inventors: Yu Liao, Longmont, CO (US); Wenyi Jin, San Jose, CA (US); Shiva Prasad Kotagiri, San Jose, CA (US); Jihong Ren, Sunnyvale, CA (US)

(73) Assignee: Intel Corporation, Santa Clara, CA (US)

(21) Appl. No.: 15/488,994

(22) Filed: Apr. 17, 2017

(51) Int. Cl. H04L 27/36; H04L 25/03

(52) U.S. Cl. CPC H04L 27/361; H04L 25/03273

(57) ABSTRACT

An integrated circuit for supporting a high-speed communications link. The integrated circuit may include equalization and hybrid phase detection circuitry configured to perform clock data recovery (CDR) for high-order pulse amplitude modulated (PAM) signals. The phase detector circuit includes partial oversampling sampling circuitry that generates edge samples an incoming PAM signal and Baud rate sampling circuitry that generates error and data samples on the PAM signals. Edge, data, and error samples may be passed to error minimization circuitry within an adaptation circuit that may dynamically compute contributions to a weighted phase error by oversampling and Baud rate components. The adaptation circuit may use the weighted phase error to adjust the phase of a recovered clock signal used to recover data transmitted through the high speed communications link.

### BACKGROUND

Communications links such as high-speed input-output (I/O) communications links typically include a transmitter (TX) module that transmits a serial data bit steam across a channel to a receiver (RX) module. Usually, the serial data bit stream does not include an associated clock signal. To ensure faithful transmission of data from the TX module to the RX module, the RX module may include clock data recovery (CDR) circuitry to reconstruct the clock signal used during transmission. The recovered clock signal allows the RX module to accurately sample incoming serial data during data recovery.

Many communications links use non-return-to-zero (NRZ) signaling in which a binary signal is encoded in a two-state pulse amplitude modulation with no rest condition (i.e., 0V does not encode a logic state). For example, logic “1” may be represented by +1V, while logic “0” may be represented by −1V (rather than 0V). In transceivers using two-state NRZ signaling, typical CDR circuitry includes a single data sampler and a single edge sampler to recover the frequency and phase of the TX clock signal used to transmit a serial data bit stream.

In designing high-speed communications links, it may be desirable to encode data using higher order pulse amplitude modulation (PAM) signaling, such as PAM4. As opposed to typical two-level NRZ signaling, PAM4 signals have four distinct levels (e.g., −3, −1, +1, and +3). While PAM4 signals may allow for a higher communication bandwidth, the presence of higher order modulations in PAM4 significantly complicates implementation of conventional clock recovery algorithms in transceivers using PAM4 signaling.

In many cases, oversampled clock recovery is an effective method to handle a variety of waveform shapes and clock patterns, but is very costly in terms of hardware and algorithmic efficiency for PAM4 signals. On the other hand, Baud rate clock recovery is much more resource efficient in PAM4, but produces noticeably off-centered data sampling when the received signal does not have a sharp peak and is less effective in handling clock patterns.

It is in this context that the embodiments described herein arise.

### BRIEF DESCRIPTION OF THE DRAWINGS

FIG. 1 is a diagram of an illustrative communications link in accordance with an embodiment.

FIG. 2 is a diagram of illustrative clock data recovery circuitry in accordance with an embodiment.

FIGS. 3A and 3B show a wave-form and an eye diagram for a two-state NRZ signal.

FIGS. 4A and 4B show an illustrative wave-form and an eye diagram for a four-state pulse amplitude modulated (PAM) signal in accordance with an embodiment.

FIG. 5 is a diagram of an illustrative hybrid phase detector for implementing clock data recovery in accordance with an embodiment.

FIG. 6 is a diagram of illustrative partial edge oversampling and baud rate sampling circuits coupled to adaptation logic in accordance with an embodiment.

FIG. 7 is a flow chart of illustrative steps for computing and correcting phase error in a recovered clock signal in accordance with an embodiment.

FIGS. 8A, 8B, and 8C are diagrams showing early and late edge samples of an illustrative PAM signal in accordance with an embodiment.

FIG. 9 is a diagram showing early and late data samples of an illustrative PAM signal in accordance with an embodiment.

### DETAILED DESCRIPTION

The following embodiments describe methods and circuitry for implementing hybrid clock data recovery (CDR) in high-speed serial communications links adapted to transmit higher-order pulse amplitude modulated (PAM) signals.

It will be recognized by one skilled in the art, that the present exemplary embodiments may be practiced without some or all of these specific details. In other instances, well-known operations have not been described in detail in order not to unnecessarily obscure the present embodiments.

Communications links are commonly used to transport data between separate integrated circuits packages, printed circuit boards, components, systems, etc. Such communications links may be used to connect integrated circuits that include communications capabilities, such as memory chips, digital signal processing circuits, microprocessors, application specific integrated circuits, programmable logic device integrated circuits, field-programmable gate arrays, application specified standard products, or any other suitable integrated circuit.

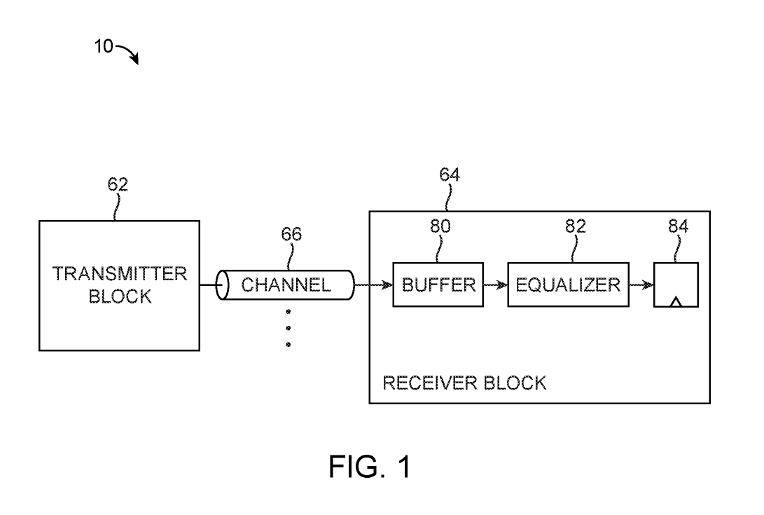

A high-speed link might, as an example, carry data at 10 gigabits per second or more. A high-speed communications system 10 is shown in FIG. 1. Communications system 10 may include transmitter (TX) circuitry such as TX block 62, a channel such as channel 66, and receiver (RX) circuitry such as RX block 64. Channel 66 may connect TX block 62 to RX block 64 (e.g., transmitter 62 may produce data that is to be transmitted to receiver 64 over link 66).

TX circuitry 62 may be formed on a first integrated circuit while RX circuitry 64 may be formed on a second integrated circuit (as an example). Integrated circuit devices 62 and 64 may be mounted on a printed circuit board (PCB). Transmitter block 62 may convey data to RX block 64 through channel 66. If desired, more than one channel may be used to link TX block 62 to RX block 64.

In general, channel 66 may be formed from any suitable physical transmission medium. Examples of transmission paths that may be used in channel 66 include traces on printed circuit boards, differential signaling paths made up of pairs of conductive wires, coaxial cable paths (e.g., a CAT 5 cable), fiber optic cable paths, combinations of such paths, backplane connectors, or other suitable communications link paths. In a typical system, integrated circuits 62 and 64 may be mounted on one or more circuit boards and channel 66 may involve transmission line structures fabricated on the circuit board or boards.

This example is merely illustrative. Communications links of the type described in connection with FIG. 1 may be used to provide data transport between integrated circuits, printed circuit boards, circuits within a single integrated circuit, systems, etc.

Receiver circuitry 64 may include an RX buffer such as buffer 80, an RX equalizer such as equalizer 82, and a data latching circuit 84. In the example of FIG. 1, the second terminal of channel 66 may be connected to an input of buffer 80. Buffer 80 may receive data from channel 66. Buffer 80 may have an input differential resistance of 10 Ohms for impedance matching (i.e., assuming the second terminal of channel 66 has an output differential resistance of 10 Ohms). Buffer 80 may provide additional pre-amplification for the received data, if desired.

Buffer 80 may output the received data to equalization circuitry 82. Equalization circuitry 82 may provide further high-frequency boosting or direct signal level boosting to compensate for any undesired frequency-dependent signal loss commonly seen in high-speed serial links (e.g., losses in copper-based channels that exhibit undesired low-pass transfer characteristics that result in signal degradation at high data rates). Equalization circuitry 82 may implement linear equalization schemes such as finite impulse response (FIR) and feed forward equalization (FFE) schemes or nonlinear adaptive equalization schemes such as infinite impulse response (IIR) or decision feedback equalization (DFE) schemes (as examples).

Equalizer 82 may output the received data that has been equalized to RX data latch 84. Data latch 84 may be a serial-in parallel-out (SIPO) or a de-serializer data circuit (as an example). In this example, data source 84 may convert the serial data bit stream to parallel data for subsequent processing.

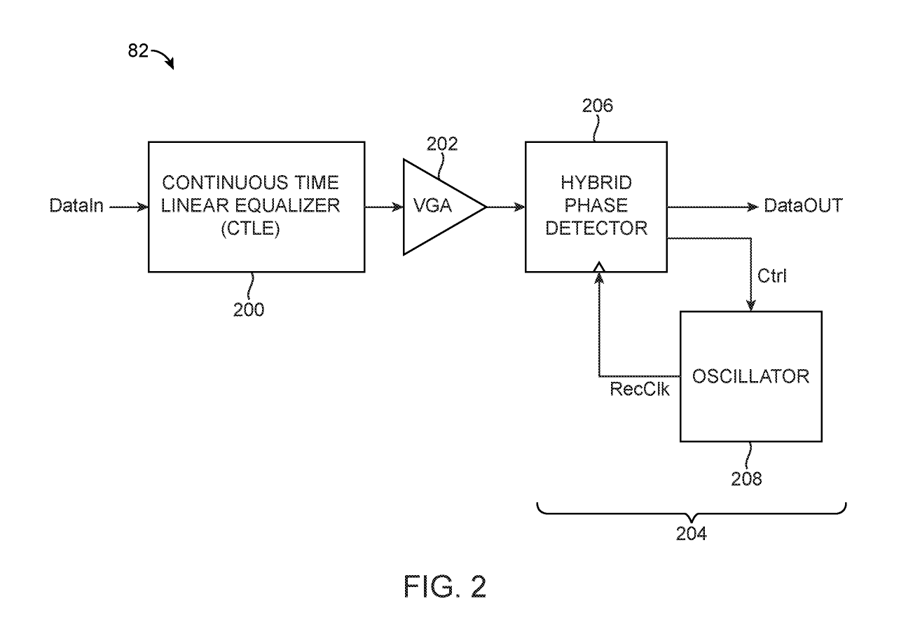

FIG. 2 is a diagram of exemplary equalization circuitry 82 in accordance with an embodiment. Equalizer 82 may include continuous time linear equalizer (CTLE) 200 and clock data recovery (CDR) circuitry 204. CDR circuit 204 may further contain hybrid phase detector 206 and oscillator 208. Optionally, an amplifier such as variable gain amplifier (VGA) 202 may be interposed between CTLE 200 and CDR circuitry 204.

Continuous time linear equalizer 200 may receive a serial data bit stream DataIn. The serial data bit stream received from channel 66, however, may contain significant high frequency amplitude distortions that cause intersymbol interference on the receiver side. CTLE circuit 200 may therefore provide a desired peaking gain (e.g., an adjustable gain difference between a high frequency AC gain and a low frequency DC gain). Alternatively, CTLE 200 may restore the transmitter/channel characteristic towards a reference characteristic with little to no intersymbol interference in order to reconstruct the serial data bitstream in a usable form.

Clock data recovery (CDR) circuitry 204 may receive an equalized data signal from CTLE circuit 200. In one embodiment, hybrid phase detector 206 of CDR circuitry 204 may contain data samplers and edge samplers to recover the phase of clock used to transmit the serial bit stream over channel 66. Phase, frequency, period, or other relevant parameters of the recovered clock signal may be adjusted based on the edge and data samples and output to oscillator 208 as control signals. Oscillator 208 may then generate the physical waveform of the recovered clock and output RecClk back to hybrid phase detector 206 in a continuous feedback process. Phase detector circuit 206 may then use the recovered clock to sample the equalized serial bit stream to generate recovered data DataOut that may be output from CDR circuit.

Conventional TX/RX modules encode data serially using a two-level, non-return-to-zero (NRZ) signaling in which logic “1” is represented by a positive voltage state (e.g., +1V) and logic “0” is represented by a negative voltage state (e.g., −1V). In other words, typical NRZ signals have no logic state represented by 0V, sometimes called a rest condition.

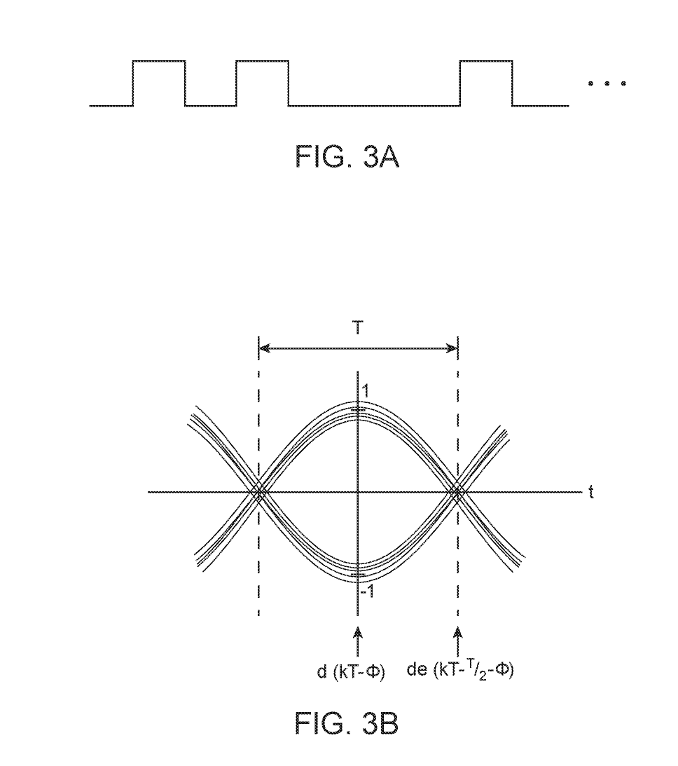

The waveform of an illustrative NRZ serial data signal is shown in FIG. 3A. Serial data bit streams using NRZ signaling typically encode a data word by transmitting a single bit on each rising/falling edge of a corresponding clock. In the example of FIG. 3A, the serial bit stream may be “010100010” if sampled by a clock with a period equal to the time between the first rising edge and first falling edge. With a 2× oversampled clock, however, the bit stream may be “001100110000001100.” Thus, data recovered by sampling a serial bit stream may depend highly on the frequency and phase of the sampling clock.

An eye diagram of an illustrative two-state NRZ signal is shown in FIG. 3B. The eye diagram may, for example, represent an expected oscilloscope display when an NRZ serial data signal with minimal signal distortion is repetitively sampled. As shown in FIG. 3B, the signal voltage may be bounded between −1V and +1V, with a signal voltage of 0V occurring only during signal transitions. The signal value at an edge may be denoted by de. In the example of FIG. 3B, the time between edge traces is denoted by period T. For an NRZ signal with the eye diagram of FIG. 3B, encoded data d may be obtained by sampling the bit stream at time t=kT−φ, where φ is the phase and k is a natural number. The corresponding edge then occurs a half-cycle later, at time t=kT+T/2−φ. In this way, the eye diagram of FIG. 3B shows a synchronized superposition of all possible signal values of a two-level NRZ signal with period T and phase φ during one clock cycle.

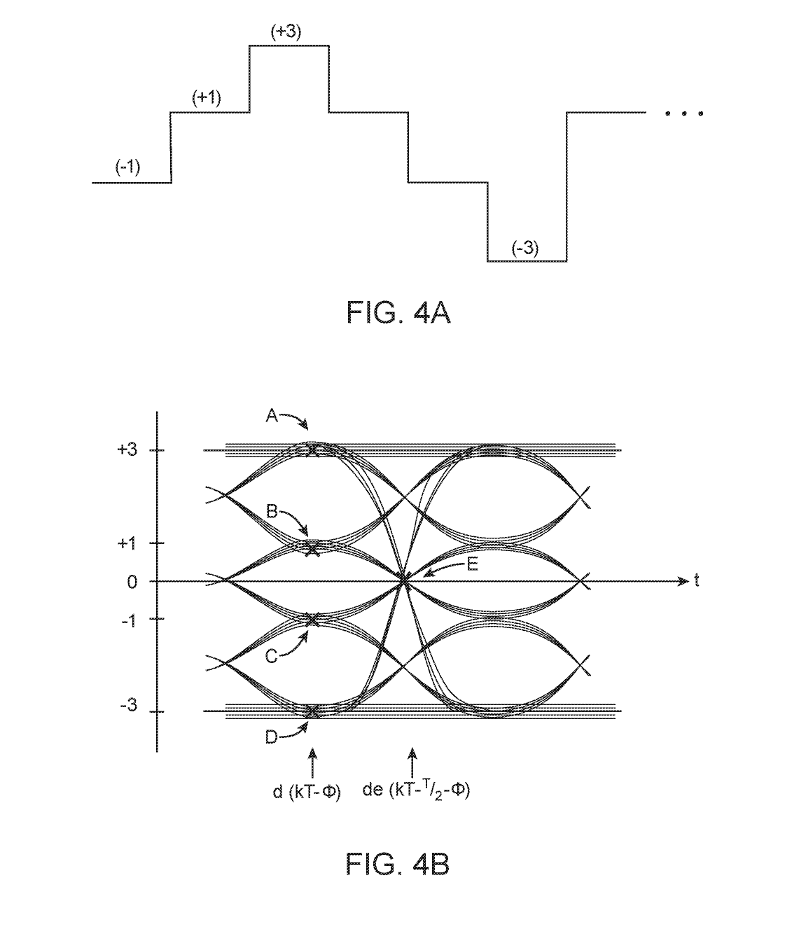

While NRZ signaling is conventional in many high-speed communications links, higher bandwidths may be achieved using signals with higher order modulations, such as four-state pulse amplitude modulation (PAM4). A diagram of an illustrative PAM4 waveform in shown in FIG. 4A. As shown in FIG. 4A, PAM4 signals can assume one of four possible signal values (e.g., −3, −1, +1, and +3) during a given clock cycle. For example, a signal value of −3V may correspond to logic “00,” a value of −1V may correspond to logic “01,” a signal value of +1 may correspond to logic “10,” and a value of +3V may correspond to logic “11” if the PAM4 waveform is used to transmit serial data. Thus, in a PAM4 signaling scheme, twice as much information may be transmitted using a serial bit steam in the same number of clock cycles.

FIG. 4B shows an eye diagram of an illustrative PAM4 signal. The eye diagram of FIG. 4B may represent a superposition of all values of an ideal PAM4 signal having period T and phase φ over a clock cycle. As shown by the signal trace of the left side of the eye diagram, sampling the PAM4 bitstream during the data cycle (e.g., at t=kT−φ) may yield a signal value d of −3V, −1V, +1V or +3V, as shown by the signal traces intersecting points D, C, B, and A, respectively. The signal values of −3V, −1V, +1V and +3V are merely illustrative, and in general any four suitable signal values may be used.

Half a clock period later, at time t=kT+T/2−φ, the PAM4 signal may transition to another one of the four possible signal values as shown by the signal traces on the right hand side of the eye diagram. Thus, a PAM4 signal has twelve possible transitions (four possible values times three possible transition destinations) compared to the two possible transitions of a conventional two-state NRZ signal. As shown in FIG. 4B, a PAM4 signal may have three transition edges, sometimes called transition thresholds. As an example, the group of “threshold zero” transitions for which the initial and final signal values sum to zero may include the transitions −3V to +3V, +3V to −3V, −1V to +1V and +1V to −1V. Referring to FIG. 4B, the threshold zero transitions may be represented by the signal traces passing through point E.

In general, PAM4 and other higher order pulse amplitude modulation schemes such as PAM8 and PAM16 have a greater number of allowed signal states, and thus a greater number of possible transitions and transition thresholds. As a result, clock data recovery techniques that employ edge sampling (e.g., oversampled CDR) may require significantly more hardware resources and computation time in PAM4 than in two-state signal environments. Oversampling PAM4, PAM8 and higher order bitstreams may require a larger number of data and edge slicers compared to CDR methods that sample only once per signaling event (e.g., Baud rate CDR).

Additionally, conventional oversampled CDR techniques require the data signal RX to be sampled several times per data cycle. Oversampling in this manner may require generating an appropriate number of additional sampling clock signals with a predetermined phase offset. For example, sampling the data signal at the rising edge, falling edge, and data portions of a clock cycle may require one clock signal of a given frequency and three additional clock signals of the same frequency with phase offsets of 90, 180 and 270 degrees. However, generating additional high speed clock signals may adversely affect power consumption and routing congestion in the transceiver device. CDR algorithms that require multiple samples per clock cycle, while complex enough to handle a variety of waveform shapes and clock patterns, also demand significantly more computation time and/or processing power in comparison to Baud rate algorithms.

Baud rate CDR techniques, which sample the RX bitstream only once per signal change, are more cost effective than oversampling for higher order modulations such as PAM4. Because Baud rate algorithms rely on a smaller number of data samples, however, these algorithms may have difficulty handling various clock patterns, sometimes leading to bit errors in the recovered RX data. Additionally, if the received data signal does not have a sharp peak, Baud rate CDR techniques may result in noticeably off-center sampling in comparison to oversampled CDR.

A clock data recovery scheme for signals with higher order modulations that balances the advantages of oversampled CDR and Baud rate CDR while minimizing their respective disadvantages may therefore be desirable. This hybrid CDR scheme would be more cost-effective than oversampled CDR, but have more complexity than Baud rate CDR, allowing it to handle clock patterns and a wider variety of PAM waveforms.

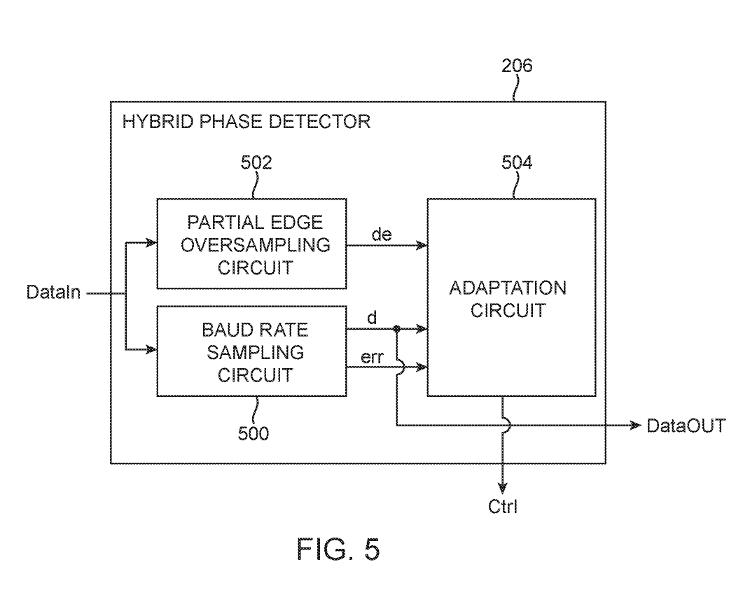

FIG. 5 shows a block diagram of hybrid phase detector 206 that may be used to implement a hybrid CDR algorithm in higher order PAM environments such as PAM4. In particular, hybrid phase detector 206 may include partial edge oversampling circuit 502. Partial edge oversampling circuit 502 may be used to sample incoming data signal DataIn at a subset of allowed transition edges. For example, if DataIn is a PAM4 bitstream, partial edge oversampling circuit 502 may sample the four “threshold zero” transitions of the PAM4 signal shown at point E in FIG. 4B. The sampled edge data de may then be passed to adaptation circuit 504.

Hybrid phase detector 206 may also include Baud rate sampling circuit 500. Baud rate sampler circuit 500 may be used to sample incoming bitstream DataIn during the data portions of the signal. For the exemplary PAM4 signal shown in FIG. 4B, one or more data slicers in Baud rate sampler circuit 500 may be used to sample the signal at or around points A, B, C, and D. Data d (i.e., signal values) may then be passed to adaptation circuit 504. Baud rate sampling circuit 500 may also pass Baud rate error signal err to adaptation logic 504.

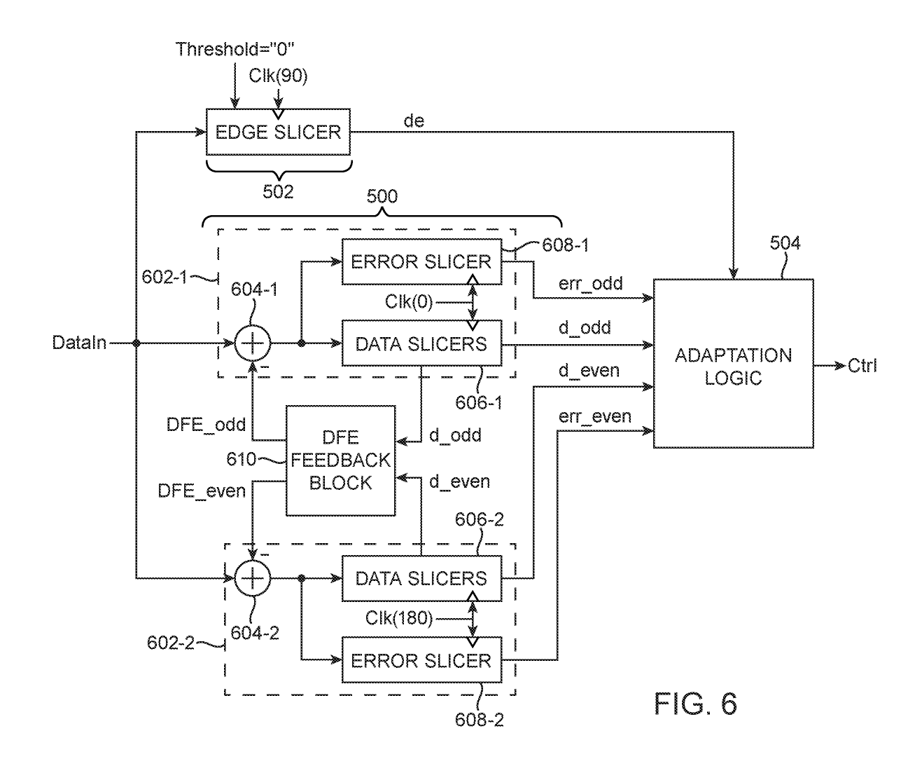

Adaptation circuit 504 may monitor edge data signal de, Baud rate data signal d, and Baud rate error signal err and adjust the frequency and/or phase of the sampling clock accordingly. Phase and frequency information may be output as control signal Ctrl to an oscillator such as oscillator 208 of FIG. 2, which may generate the specified waveform and pass the recovered clock back to hybrid phase detector 206 in a continuous feedback process. Since the recovered clock is in turn used to sample data signal DataIn, adaptation circuit 504 may control operation hybrid phase detector 206 by dynamically (i.e., continuously) updating the sampling clock with corrected phase/frequency information. Further details of adaptation logic 504 will become clear from the description of FIGS. 6-9.

FIG. 6 is a more detailed block diagram of Baud rate sampling circuit 500 and partial edge oversampling circuit 502 that may be included in hybrid phase detector 206. As shown in FIG. 6, Baud rate sampling circuit 500 may include an odd portion 602-1 and an even portion 602-2. Odd portion 602-1 may include data slicers 606-1 and error slicer 608-1, each clocked by signal Clk(0). Odd Baud rate sampling portion 602-1 may also include odd summation node circuit 604-1.

Similarly, even Baud rate sampling portion may include data slicers 606-2 and error slicer 608-2, each clocked by signal Clk(180). Clk(180) may be a clock signal with the same frequency as Clk(0), but with a phase offset of 180 degrees (e.g., the rising edge of Clk(180) may occur half a clock period later than the rising edge of Clk(0)). For example, if odd data slicers 606-1 sample DataIn at the rising edge of Clk(0), even data slicers 606-2 would sample DataIn at the falling edge of Clk(0). Like odd portion 602-1, even Baud rate sampling portion 602-2 may include even summation node circuit 604-2.

Partial edge oversampling circuit 502 may include edge slicer 502 clocked by signal Clk(90). Clk(90) may have the same frequency as Clk(0), but with a phase offset of 90 degrees (e.g., the rising edge of Clk(90) may occur a quarter clock period later than the rising edge of Clk(0)). Edge sampler 502 may receive a control signal corresponding to the threshold voltage of the transition edge being sampled. In the example of FIG. 6, control signal “threshold=0” may configure edge slicer 502 to sample transitions with a threshold voltage of zero (i.e., a subset of allowed transitions). If DataIn is the exemplary PAM4 signal shown in FIG. 4B, edge sampler 502 may output an edge data signal de to adaptation logic 504 in response to detecting a threshold zero transition. Configuring edge slicer 502 to detect threshold zero transitions is merely illustrative. In general, edge slicer 502 may be configured to sample any suitable subset of transition thresholds (e.g., −2V, +2V or the like).

It should be appreciated that phase detectors implementing pure oversampled CDR typically have more than one edge sampler. For example, phase detectors for pure oversampled CDR in PAM4 environments may include three or more edge samplers, while PAM8 phase detectors may include include seven or more edge samplers (related to the number of possible transition thresholds). In contrast, partial edge oversampling circuit 502 used in hybrid phase detector 506 may include fewer edge detectors (e.g., only one slicer in the embodiment of FIG. 6), which may save considerable hardware and processing resources in comparison to pure oversampling.

During normal operation of the hybrid phase detector shown in FIG. 6, adaption logic 504 may implement a continuous feedback process to match the phase of the sampling clock with the phase of the clock used to transmit signal DataIn.

In one embodiment, DataIn may be the output of a linear equalizer such as continuous time linear equalizer (CTLE) 200 shown in FIG. 2. In another embodiment, DataIn may be an amplified CTLE output received from VGA 202. Odd summation node circuit 604-1 may have an input that receives DataIn and a second input that receives odd scaling coefficients DFE_odd from DFE scaling block 610. Data sampler 606-1 may be high gain flip-flops, comparators, or other circuitry that converts the voltage at odd-summation node circuit 604-1 to a corresponding digital signal. Odd DFE scaling coefficients DFE_odd may be computed based on the data latched at the output of odd data samplers 606-1 (i.e., d_odd) that is input to DFE feedback block 610 and passed to summation node circuit 604-1 in order to offset amplitude distortions in the incoming DataIn. These scaling coefficients may be dynamically updated throughout the phase detection process. Odd data samplers 606-1 and odd error sampler 608-1 may be clocked with sampling clock signal Clk(0). These samplers may output signals d_odd and err_odd to adaptation logic 504. Data samplers 606 may sometimes be referred to as data “slicers.”

Similarly, even summation node circuit 604-2 may have an input that also receives DataIn and a second input that receives even scaling coefficients DFE_even from DFE scaling block 610. Even scaling coefficients DFE_even may or may not be the same as odd scaling coefficients DFE_odd. Like odd data samplers 606-1, even data samplers 606-2 may be high gain flip-flops, comparators or other circuitry that converts the analog signal received at even summation node circuit 604-1 to a corresponding digital signal. DFE scaling coefficients DFE_even may be dynamically computed based on the data latched at the output of even data samplers 606-2 (i.e., d_even) and input to DFE feedback block 610 during a given cycle of Clk(180). Even data sampler 606-2 and even error sampler 608-1 may output signals d_even and err_even to adaptation logic 504.

Adaptation logic 504 may contain error minimization adaptation circuitry that attempts to minimize the phase difference between TX clock used to transmit DataIn and the recovered sampling clock (e.g., RecClk of FIG. 2). In particular, adaptation logic 504 may dynamically compute an oversampling phase error and a Baud rate phase error based on the values of d_odd, d_even, err_odd, and err_even during each data cycle, continuously adjusting the phase parameter supplied to oscillator 208 in order to minimize these values either individually or in linear combination.

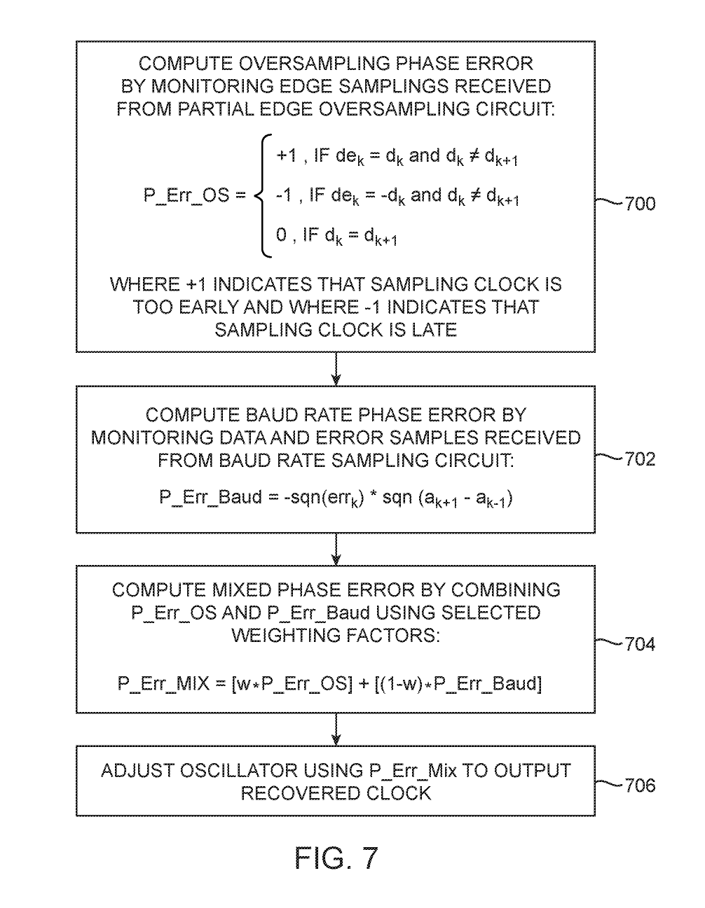

FIG. 7 is a flowchart illustrating the steps of a method for computing phase error that may be implemented by adaptation logic in hybrid phase detector 206. At step 700, adaptation logic may compute the phase error contribution from oversampling in partial edge oversampling circuit 502. Adaptation logic such as adaptation circuit 504 may continuously monitor edge samples taken by edge slicer 502. The oversampling phase error for the k^{th} data cycle may be computed according to the formula:

$$P\_Err \_OS = \{ \begin{matrix}+ 1 & if {de}_{k} = {d}_{k} and {d}_{k} \neq {d}_{k + 1} \\ - 1 & if {de}_{k} = - {d}_{k} and {d}_{k} \neq {d}_{k + 1} \\ 0 & if {d}_{k} = {d}_{k + 1}\end{matrix} \qquad ( 1 )$$

If a transition occurred (i.e., if dₖ≠dₖ₊₁) and if the value of the DataIn at an edge is equal to the value of DataIn during the data portion of the same cycle (i.e., if deₖ=dₖ), the sampling clock may be too early. This follows from the fact that, in general, the edge values of DataIn are not equal to the signal values of DataIn. For example, the PAM4 signal shown in FIGS. 4A and 4B has allowed signal values of −3V, −1V, +1V, and +3V, but the resulting edge values are −2V, 0V, and +2V. Thus, if the data sample and subsequent edge sample of a data cycle are equal, this may indicate that edge slicer 502 sampled too early. In this case, the oversampling phase error P_Err_OS is assigned a normalized value of 1.

Similarly, if a transition occurred (i.e., if dₖ≠dₖ₊₁) and if the edge value of DataIn is equal to negative of the signal value, the threshold zero transition has already occurred and the sampling clock is too late. In this case, the oversampling phase error P_Err_OS is assigned a normalized value of −1.

If, however, the signal value dₖ is equal to the signal value during the subsequent data cycle dₖ₊₁, a transition did not occur. In this case, there is insufficient information to detect phase error in the sampling clock only using data dₖ and threshold zero edge data deₖ. P_Err_OS may therefore be assigned a value of 0.

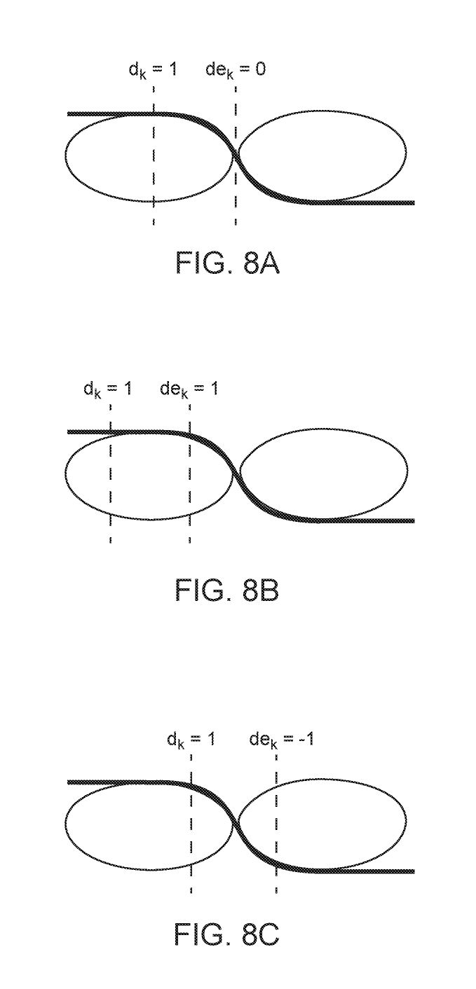

It should be appreciated that the oversampled phase error P_Err_OS may be assigned any suitable values to designate early sampling, late sampling, and no information cases; the use of +1, −1, and 0 in the above cases is merely illustrative. The cases of on-time, early, and late edge sampling are illustrated further in the simplified eye diagrams of FIGS. 8A, 8B, and 8C, respectively.

FIG. 8A shows an on-time edge sample during threshold zero transition on a simplified eye diagram of a PAM signal. The transition shown in FIG. 8A may, for example, be the +1V to −1V transition visible in the PAM4 eye diagram of FIG. 4B. In this case, the data sample (dₖ) before the transition returns a signal value of +1, while the edge sample returns an edge value (deₖ) of 0.

FIG. 8B illustrates an early edge sample during the threshold zero transition of FIG. 8A on a simplified eye diagram of a PAM signal. In this case, there is a phase error in the sampling clock such that the sampling edge occurs slightly earlier than the sampling clock of FIG. 8A. As a result, the data sample dₖ still returns a correct signal value of +1, but the early edge sample returns a value of deₖ=dk=+1, since edge sample occurs before the actual signal transition. Thus, when calculating oversampling phase error due to edge detection, the sampling clock may be defined as early if deₖ=dₖ.

FIG. 8C illustrates a late edge sample during the threshold zero transition of FIG. 8A on a simplified eye diagram of a PAM signal. In this case, there is a phase error in the sampling clock such that the sampling edge occurs slightly later than the sampling clock of FIG. 8A. As a result, the data sample dₖ₋₁ still returns a correct signal value of +1, but the late edge sample returns a value of deₖ=−1. This is equal to the signal value during the subsequent data cycle (i.e., −dₖ for a threshold zero transition), since the edge sample occurs before the actual signal transition. Thus, when calculating oversampling phase error due to edge detection, the sampling clock may be defined as late if deₖ=−dₖ.

Referring back to FIG. 7, adaptation logic may compute the contribution to the overall phase error from Baud rate sampling circuit at step 702. Data and error signals supplied by the Baud rate sampling circuit may be continuously monitored to dynamically compute the Baud rate phase error contribution during each data cycle. During Baud rate phase detection, no edge samples are used. Since data signals alone are insufficient to detect timing errors when sampling, Baud rate phase detection may involve computing an intermediate error signal (i.e., eₖ). In particular, the Baud rate phase error associated with the k^{th} data cycle may be computed according to the formula:

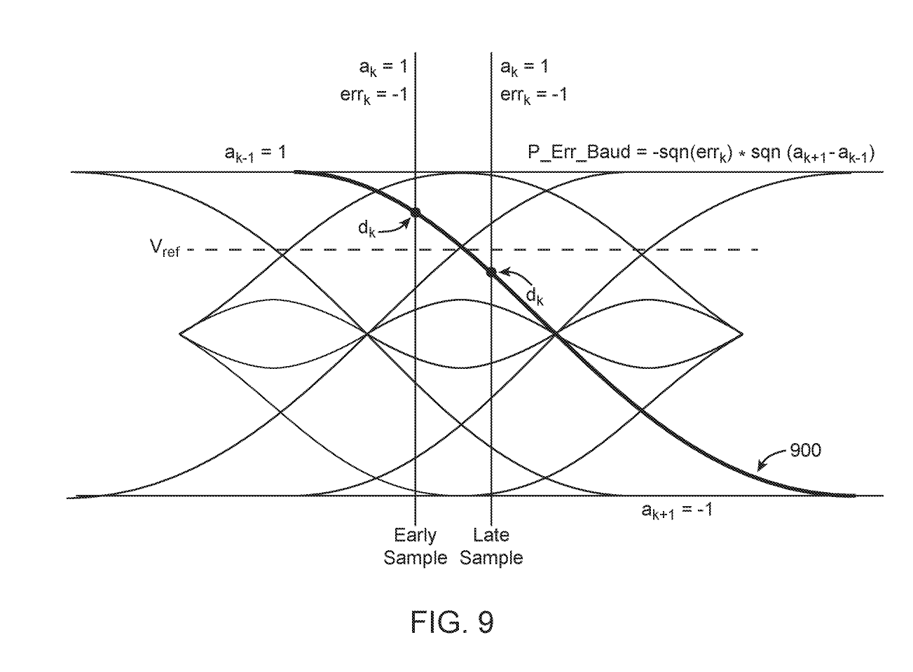

P_Err_Baud=−sgn (eₖ)*sgn (aₖ₊₁−aₖ₋₁₁) (2)

where aₖ₊₁ and aₖ₋₁ are either +1 or −1 depending on the sign of k+1 and k−1 data samples, respectively. For example, aₖ₋₁ may be −1 if dₖ₋₁ is negative. Error signals eₖ may be computed based on discrepancies between sampled data signals dₖ and an expected Baud rate locking condition (e.g., by comparing dₖ to a fixed reference voltage). The algorithm for computing eₖ and Baud rate phase error P_Err_Baud is described in further detail with respect to FIG. 9.

FIG. 9 illustrates early and late data samples when implementing Baud rate phase detection on an illustrative PAM4 waveform 900. In general, the Baud rate error signal, such as the error signal eₖ in FIG. 7, is computed according to:

eₖ=dₖ−(aₖ*V_{ref}) (3)

where aₖ is 1 if the signal value dₖ is positive and −1 if the sampled signal value dₖ is negative. V_{ref} may be a reference voltage that depends on one or more of the allowed signal values. Thus, eₖ may be the voltage difference between an expected signal value V_{ref} and the sampled signal value dₖ.

The Baud rate phase detection algorithm may determine whether the sample clock is early or late by comparing the sign of the error with the signs of the signal before and after transition. In particular, the phase error P_Err_Baud may be computed by equation (2) described in connection with FIG. 7. As with the oversampled phase error, P_Err_Baud may be either +1, −1 or 0. A Baud rate phase error of −1 may indicate that the sampling clock is too late, whereas a phase error of +1 may indicate that the sampling clock is too early.

In the example of FIG. 9, sampling PAM4 waveform 900 using the early clock may yield dₖ greater than the reference voltage V_{ref}. Additionally, aₖ=1 since dₖ is positive. Thus, eₖ is positive, while aₖ₊₁ minus aₖ₋₁ is negative. The sign of P_Err_Baud, according to the above formula, is therefore positive. After computing a positive Baud rate phase error as above, a Baud rate phase detector may adjust the phase of the sampling clock such that the sampling edge occurs later.

On the other hand, a late sample of waveform 900 may yield dₖ less than the reference voltage V_{ref}. Here, aₖ is equal to 1 since dₖ is still positive. Thus, eₖ is negative, while aₖ₊₁ minus aₖ₋₁ is again negative. The sign of P_Err_Baud is therefore negative. After computing a negative Baud rate phase error as above, a Baud rate phase detector may adjust the phase of the sampling clock such that the sampling edge occurs earlier.

Referring back to FIG. 7, a mixed phase error including both oversampling and Baud rate contributions may be computed according at step 704 according to a predetermined weighting scheme. In particular, the oversampled phase error P_Err_OS may be scaled by a first weighting factor and the Baud rate phase error P_Err_Baud may be scaled by a second weighting factor. The two scaled phase error contributions may then be added together. In one such weighting scheme, the mixed phase error P_Err_Mix may be computed according to the formula

P_Err_Mix={w*P_Err_OS}+{(1−w)*P_Err_Baud} (4)

where w is a numerical weighting factor that quantifies the relative proportion of oversampling to Baud rate phase detection implemented by the hybrid phase detector (e.g., the number of edge samplers in partial edge oversampling circuit 502). In this case, the weighting parameter w may be a real number between 0 and 1, inclusive. For example, w=0 may describe a phase detector implementing pure Baud rate CDR, and w=1 may describe a phase detector implementing pure oversampled CDR. For a hybrid phase detector implementing a hybrid CDR algorithm, w may be a fractional value between 0 and 1.

Computed in this way, P_Err_Mix may represent the overall phase error in the recovered clock signal. Thus, at step 706, the value of P_Err_Mix may be used to adjust an oscillator such as oscillator 208 such that the oscillator outputs a corrected recovered clock. In particular, adaptation logic may change the value of the phase parameter output to the oscillator based on sign and magnitude of P_Err_Mix. By continuously computing P_Err_Mix over a number of data cycles and adjusting the oscillator in this way, adaptation logic within the hybrid phase detector may reduce or eliminate any phase difference between the TX clock used to transmit a PAM bitstream and the recovered clock generated by the RX oscillator.

The embodiments thus far have been described with respect to integrated circuits. The methods and apparatuses described herein may be incorporated into any suitable circuit. For example, they may be incorporated into numerous types of devices such as programmable logic devices, application specific standard products (ASSPs), application specific integrated circuits (ASICs), microcontrollers, microprocessors, central processing units, graphics processing units (GPUs), etc. Examples of programmable logic devices include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The programmable logic device described in one or more embodiments herein may be part of a data processing system that includes one or more of the following components: a processor; memory; IO circuitry; and peripheral devices. The data processing can be used in a wide variety of applications, such as computer networking, data networking, instrumentation, video processing, digital signal processing, or any suitable other application where the advantage of using programmable or re-programmable logic is desirable. The programmable logic device can be used to perform a variety of different logic functions. For example, the programmable logic device can be configured as a processor or controller that works in cooperation with a system processor. The programmable logic device may also be used as an arbiter for arbitrating access to a shared resource in the data processing system. In yet another example, the programmable logic device can be configured as an interface between a processor and one of the other components in the system. In one embodiment, the programmable logic device may be one of the family of devices owned by INTEL®/ALTERA® Corporation.

Although the methods of operations were described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

### EXAMPLES

The following examples pertain to further embodiments.

Example 1 is an integrated circuit comprising: a first sampling circuit that receives a data signal and obtains a corresponding edge sample; a second sampling circuit that receives the data signal and obtains a corresponding error sample; and adaptation logic circuitry that adjusts the first and second sampling circuits based on the edge sample and the error sample.

Example 2 is the integrated circuit of Example 1, where the first sampling circuit optionally comprises an oversampling circuit.

Example 3 is the integrated circuit of any one of Examples 1-2, where the second sampling circuit optionally comprises a baud rate sampling circuit.

Example 4 is the integrated circuit of any one of Examples 1-3, where the second sampling circuit optionally further obtains a data sample that is fed to the adaptation logic circuitry.

Example 5 is the integrated circuit of any one of Examples 1-4, where the first and second sampling circuits optionally receive a data signal that transitions from a first data value to a second data value, and the edge sample is optionally sampled while the data signal is transitioning from the first data value to the second data value.

Example 6 is the integrated circuit of any one of Examples 1-5, where the data signal is optionally modulated using at least a fourth order pulse amplitude modulation (PAM) scheme.

Example 7 is the integrated circuit of any one of Examples 1-6, where the data signal has a predetermined number of transition thresholds, and the first sampling circuit is optionally configured to sample only a subset of the predetermined number of transition thresholds.

Example 8 is the integrated circuit of any one of Examples 1-7, where the adaptation logic circuitry optionally uses the edge sample to determine whether a first sampling clock associated with the first sampling circuit is early or late and to generate a first error signal.

Example 9 is the integrated circuit of any one of Examples 1-8, where the adaptation logic circuitry optionally uses the error sample to determine whether a second sampling clock associated with the second sampling circuit is early or late and to generate a second error signal.

Example 10 is the integrated circuit of any one of Examples 1-9, where the adaptation logic circuitry optionally combines the first and second error signals using a predetermined weighting scheme.

Example 11 is a method of operating an integrated circuit, the method comprising: receiving a data signal; obtaining a data sample on the data signal; obtaining an error sample on the data signal; obtaining an edge sample on the data signal; and adjusting a clock signal based on the obtained data sample, error sample, and the edge sample.

Example 12 is the method of Example 11, wherein obtaining the data sample and the error sample optionally comprises sampling the data signal with a baud rate sampling circuit.

Example 13 is the method of any one of Examples 11-12, wherein obtaining the edge sample optionally comprises sampling the data signal with a partial oversampling circuit.

Example 14 is the method of any one of Examples 11-13, optionally further comprising: generating a first error value by comparing the data sample and the edge sample; and generating a second error value based on data sample and the error sample.

Example 15 is the method of any one of Examples 11-14, optionally further comprising: scaling the first error value by a first weighting factor; scaling the second error value by a second weighting factor; and computing a third error value by combining the scaled first error value and the scaled second error value, wherein adjusting the clock signal comprises dynamically adjusting the clock signal based on the third error value.

Example 16 is a communications system comprising: a transmitter that transmits a signal; and a receiver that receives the transmitted signal, the receiver comprises: a baud rate sampling circuit that obtains first samples; an oversampling circuit that obtains second samples; and an adaptation circuit that adjusts a clock signal based on the first and second samples.

Example 17 is the communications system of Example 16, where the baud rate sampling circuit optionally supports a modulation scheme selected from the group consisting of: pulse amplitude modulation (PAM) 4, PAM 8, and PAM 16.

Example 18 is the communications system of any one of Examples 16-17, where the signal has a predetermined number of allowed data transitions, and the oversampling circuit optionally evaluates only a subset of the predetermined number of allowed data transitions.

Example 19 is the communications system of any one of Examples 16-18, where the oversampling circuit optionally includes only one edge sampler.

Example 20 is the communications system of any one of Examples 16-19, where the edge sampler optionally has a threshold value of zero.

Example 21 is an integrated circuit comprising means for receiving a data signal; means for obtaining a data sample on the data signal; means for obtaining an error sample on the data signal; means for obtaining an edge sample on the data signal; and means for adjusting a clock signal based on the obtained data sample, error sample, and the edge sample.

Example 22 is the integrated circuit of Example 21, where the means for obtaining the data sample and the error sample optionally comprises means for sampling the data signal with a baud rate sampling circuit.

Example 23 is the integrated circuit of any one of Examples 21-22, where the means for obtaining the edge sample optionally comprises means for sampling the data signal with a partial oversampling circuit.

Example 24 is the integrated circuit of any one of Examples 21-23, optionally further comprising means for generating a first error value by comparing the data sample and the edge sample; and means for generating a second error value based on data sample and the error sample.

Example 25 is the integrated circuit of any one of Examples 21-24, optionally further comprising: means for scaling the first error value by a first weighting factor; means for scaling the second error value by a second weighting factor; and means for computing a third error value by combining the scaled first error value and the scaled second error value, wherein the means for adjusting the clock signal comprises means for dynamically adjusting the clock signal based on the third error value.

For instance, all optional features of the apparatus described above may also be implemented with respect to the method or process described herein. The foregoing is merely illustrative of the principles of this disclosure and various modifications can be made by those skilled in the art.

1. An integrated circuit, comprising:
a first sampling circuit that receives a data signal and obtains a corresponding edge sample;
a second sampling circuit that receives the data signal and obtains a corresponding error sample; and
adaptation logic circuitry that adjusts the first and second sampling circuits based on the edge sample and the error sample.

2. The integrated circuit of claim 1, wherein the first sampling circuit comprises an oversampling circuit.

3. The integrated circuit of claim 1, wherein the second sampling circuit comprises a baud rate sampling circuit, and wherein the error sample is computed based on discrepancies between a data signal sampled by the second sampling circuit and an expected Baud rate locking condition.

4. The integrated circuit of claim 1, wherein the second sampling circuit further obtains a data sample that is fed to the adaptation logic circuitry.

5. The integrated circuit of claim 1, wherein the first and second sampling circuits receive a data signal that transitions from a first data value to a second data value, and wherein the edge sample is sampled while the data signal is transitioning from the first data value to the second data value.

6. The integrated circuit of claim 5, wherein the data signal is modulated using at least a fourth order pulse amplitude modulation (PAM) scheme.

7. The integrated circuit of claim 6, wherein the data signal has a predetermined number of transition thresholds, and wherein the first sampling circuit is configured to sample only a subset of the predetermined number of transition thresholds.

8. The integrated circuit of claim 1, wherein the adaptation logic circuitry uses the edge sample to determine whether a first sampling clock associated with the first sampling circuit is early or late and to generate a first error signal.

9. The integrated circuit of claim 8, wherein the adaptation logic circuitry uses the error sample to determine whether a second sampling clock associated with the second sampling circuit is early or late and to generate a second error signal.

10. The integrated circuit of claim 9, wherein the adaptation logic circuitry combines the first and second error signals using a predetermined weighting scheme.

11. A method of operating an integrated circuit, the method comprising:
receiving a data signal;
obtaining a data sample on the data signal using a clock signal;
obtaining an error sample on the data signal;
obtaining an edge sample on the data signal; and
adjusting the clock signal based on the obtained data sample, error sample, and the edge sample.

12. The method of claim 11, wherein obtaining the data sample and the error sample comprises sampling the data signal with a baud rate sampling circuit, and wherein the error sample is computed based on discrepancies between the data sample and an expected Baud rate locking condition.

13. The method of claim 11, wherein obtaining the edge sample comprises sampling the data signal with a partial oversampling circuit.

14. The method of claim 11, further comprising:
generating a first error value by comparing the data sample and the edge sample; and
generating a second error value based on data sample and the error sample.

15. The method of claim 11, further comprising:
scaling the first error value by a first weighting factor;
scaling the second error value by a second weighting factor; and
computing a third error value by combining the scaled first error value and the scaled second error value, wherein adjusting the clock signal comprises dynamically adjusting the clock signal based on the third error value.

16. A system comprising:
a transmitter that transmits a signal; and
a receiver that receives the transmitted signal, wherein the receiver comprises:
a baud rate sampling circuit that obtains first samples, wherein the baud rate sampling circuit includes a plurality of data slicers and a plurality of error slicers;
an oversampling circuit that obtains second samples, wherein the oversampling circuit includes an edge slicer, and wherein the edge slicer in the oversampling circuit is the only edge slicer in the entire receiver; and
an adaptation circuit that adjusts a clock signal based on the first and second samples.

17. The system of claim 16, wherein the baud rate sampling circuit supports a modulation scheme selected from the group consisting of: pulse amplitude modulation (PAM) 4, PAM 8, and PAM 16.

18. The system of claim 16, wherein the signal having a predetermined number of allowed data transitions, and wherein the oversampling circuit evaluates only a subset of the predetermined number of allowed data transitions.

19. (canceled)

20. The system of claim 16, wherein the edge slicer has a threshold value of zero.

21. The system of claim 16, wherein one of the plurality of data slicers and one of the plurality of error slicers have inputs that are connected.
